(19) United States
(12) Patent Application Publication
(10) Pub. No.: US 2026/0358268 A1
(43) Pub. Date: Nov. 12, 2026

(54) PATTERN INSPECTION APPARATUS AND PATTERN INSPECTION METHOD

(71) Applicant: NuFlare Technology, Inc., Yokohama-shi (JP)

(72) Inventors: Masashi HASHIMOTO, Yokohama-shi (JP); Takafumi INOUE, Chigasaki-shi (JP)

(73) Assignee: NuFlare Technology, Inc., Yokohama-shi (JP)

(21) Appl. No.: 19/640,585

(22) Filed: Apr. 7, 2026

(30) Foreign Application Priority Data
May 9, 2025 (JP) 2025-078992

(51) Int. Cl. G01N 21/956; G01N 21/95

(52) U.S. Cl. CPC G01N 21/95607; G01N 21/9501; G01N 2021/95615; G01N 2021/95638; G01N 2201/1247; G01N 2201/13

(57) ABSTRACT

According to one aspect of the present invention, a pattern inspection apparatus includes: a determination circuit configured to determine a figure density for each of the plurality of stripe regions by using design pattern data to form the plurality of figure patterns; and a distribution circuit configured to distribute a part of design pattern data of a stripe region determined to have a large figure density exceeding a first threshold as a result of determination by the determination circuit to at least one stripe region having a small figure density below a second threshold different from the first threshold, in which optical image data is acquired before the stripe region determined to have the large figure density.

### CROSS-REFERENCE TO RELATED APPLICATION

This application is based upon and claims the benefit of priority from prior Japanese Patent Application No. 2025-078992 filed on May 9, 2025 in Japan, the entire contents of which are incorporated herein by reference.

### BACKGROUND OF THE INVENTION

### Field of the Invention

Embodiments described herein relate to a pattern inspection apparatus and a pattern inspection method. For example, the embodiments described herein relate to an apparatus and a method for inspecting pattern defects of a target object used for semiconductor manufacturing.

### Related Art

Recently, with an increase in the degree of integration and an increase in the capacity of a large-scale integrated circuit (LSI), a circuit line width required for semiconductor elements has decreased. These semiconductor elements are manufactured by forming circuits by exposing and transferring a pattern onto a wafer by a reduction projection exposure device commonly called a stepper, using an original pattern (also called a mask or reticle; hereinafter collectively referred to as a mask) on which circuit patterns are formed.

Further, improving yield is important for manufacturing the LSI requiring a large manufacturing cost. However, as represented by a 1-Gbit dynamic random access memory (DRAM), patterns configuring the LSI are on the order of submicron to nanometer. As one of major factors decreasing the yield, there can be a pattern defect of a mask used at the time of exposing and transferring an ultrafine pattern on a semiconductor wafer by photolithography technology. In recent years, with the miniaturization of a dimension of an LSI pattern formed on a semiconductor wafer, a dimension to be detected as a pattern defect is also extremely small. For this reason, it is desirable to improve the accuracy of a pattern inspection apparatus for inspecting a defect of a transfer mask used for manufacturing the LSI.

As an inspection method, a method of performing inspection by comparing an optical image obtained by imaging a pattern formed on a target object such as a lithography mask at a predetermined magnification using an enlargement optical system with design data has been proposed. For example, there is a “die to database (die-database) inspection” in which written data (design pattern data) obtained by converting a format of pattern-designed CAD data into an apparatus input format for a writing apparatus to input the pattern-designed CAD data when a pattern is written to a mask is input to an inspection apparatus, a design image (reference image) is generated based on the written data, and the design image is compared with an optical image to be measurement data obtained by imaging the pattern. In the inspection method in the inspection apparatus, the target object is placed on a stage, and a light flux scans the target object as the stage moves, and the inspection is performed. The target object is irradiated with a light flux by a light source and an illumination optical system. An image of light transmitted through or reflected by the target object is formed on a sensor through the optical system. The image captured by the sensor is sent as measurement data to a comparison circuit. In the comparison circuit, after positions of the images are adjusted, the measurement data and the reference data are compared according to an appropriate algorithm. When the measurement data and the reference data do not match, it is determined that there can be a pattern defect (see Published Unexamined Japanese Patent Application No. 2007-064843 (JP-A-2007-064843), for example).

Here, as the recent demand for forming more complicated patterns has increased, the amount of design pattern data to form such patterns has become enormous. Consequently, reference image generation processing takes more time when the above-described reference image is created, and inspection time may be delayed in conventional processing.

### BRIEF SUMMARY OF THE INVENTION

According to one aspect of the present invention, a pattern inspection apparatus includes:
an optical image acquisition mechanism configured to acquire optical image data for each of a plurality of stripe regions obtained by dividing an inspection region of a target object to be inspected on which a plurality of figure patterns are formed;
a determination circuit configured to determine a figure density for each of the plurality of stripe regions by using design pattern data to form the plurality of figure patterns;
a distribution circuit configured to distribute a part of design pattern data of a stripe region determined to have a large figure density exceeding a first threshold as a result of determination by the determination circuit to at least one stripe region having a small figure density below a second threshold different from the first threshold, in which optical image data is acquired before the stripe region determined to have the large figure density;
a reference image data creation circuit configured to create, for each of the stripe regions, reference image data corresponding to the optical image data by using design pattern data after the distribution by the distribution circuit; and
a comparison circuit configured to compare the optical image data with the reference image data corresponding to the optical image data.

According to another aspect of the present invention, a pattern inspection method includes:
acquiring optical image data for each of a plurality of stripe regions obtained by dividing an inspection region of a target object to be inspected on which a plurality of figure patterns are formed;
determining a figure density for each of the stripe regions by using design pattern data to form the plurality of figure patterns;
distributing a part of design pattern data of a stripe region determined to have a large figure density exceeding a first threshold as a result of determination to at least one stripe region having a small figure density below a second threshold different from the first threshold, in which optical image data is acquired before the stripe region determined to have the large figure density;
creating, for each of the stripe regions, reference image data corresponding to the optical image data by using design pattern data after the distribution; and
comparing the optical image data with the reference image data corresponding to the optical image data and outputting a result.

### BRIEF DESCRIPTION OF THE DRAWINGS

FIG. 1 is a configuration diagram illustrating an example of a configuration of a pattern inspection apparatus in a first embodiment;

FIG. 2 is a conceptual diagram for describing an example of an inspection region in the first embodiment;

FIG. 3 is a flowchart illustrating an example of main steps of an inspection method in the first embodiment;

FIG. 4 is a block diagram illustrating an example of an internal configuration of a data amount control circuit in the first embodiment;

FIG. 5 is a diagram for describing an example of a model of data distribution in the first embodiment;

FIG. 6 is a diagram for describing an example of a manner of data distribution in the first embodiment;

FIG. 7 is a diagram for describing another example of the manner of data distribution in the first embodiment;

FIG. 8 is a diagram for describing another example of the manner of data distribution in the first embodiment; and

FIG. 9 is a diagram illustrating an example of an internal configuration of a comparison circuit in the first embodiment.

### DETAILED DESCRIPTION OF THE INVENTION

Hereinafter, embodiments provide an inspection apparatus and an inspection method capable of reducing a delay in inspection time due to a delay in reference image creation.

### First Embodiment

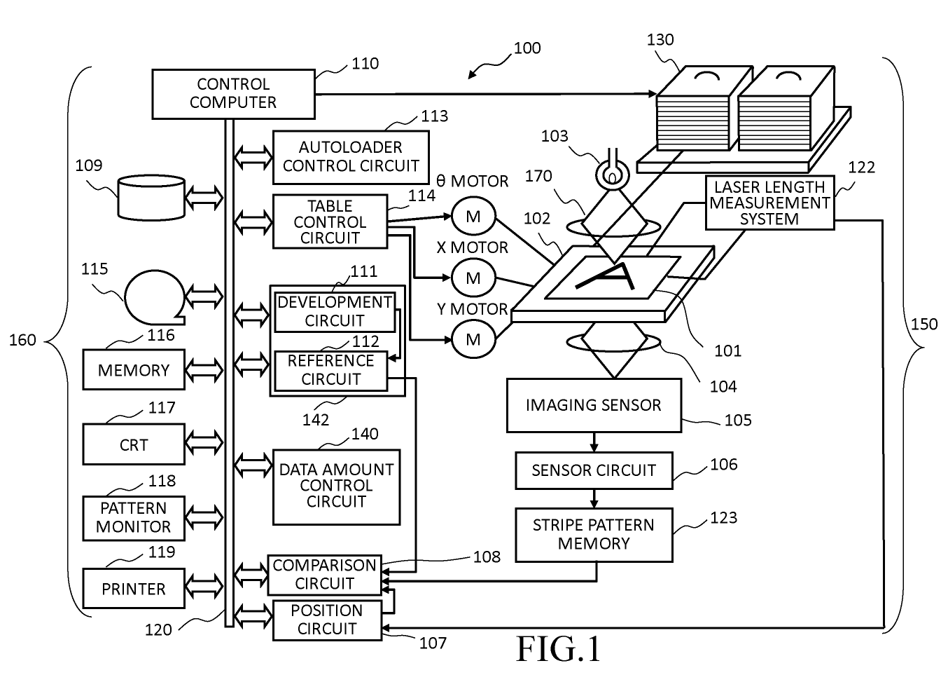

FIG. 1 is a configuration diagram illustrating an example of a configuration of a pattern inspection apparatus in a first embodiment. In FIG. 1, an inspection apparatus 100 that inspects a defect of a pattern formed on a target object, for example, a mask includes an optical image acquisition mechanism 150 and a control system circuit 160 (control unit).

The optical image acquisition mechanism 150 includes a light source 103, an illumination optical system 170, an XYθ table 102 movably arranged, a magnifying optical system 104, an imaging sensor 105 (an example of a sensor), a sensor circuit 106, a stripe pattern memory 123, a laser length measurement system 122, and an autoloader 130. A target object 101 is disposed on the XYθ table 102. Examples of the target object 101 include a photomask for exposure for transferring a pattern to a wafer. A pattern including a plurality of figure patterns to be inspected is formed in the photomask. The target object 101 is disposed on the XYθ table 102 with a pattern formation surface disposed downward, for example.

A line sensor or a two-dimensional sensor may be used as the imaging sensor 105. For example, a time delay integration (TDI) sensor is preferably used. The TDI sensor has a plurality of photosensor elements arranged two-dimensionally. When each photosensor element captures an image, a predetermined image accumulation time is set. In the TDI sensor, outputs of a plurality of photosensor elements arranged in a scanning direction are integrated and output. The plurality of photosensor elements arranged in the scanning direction image the same pixel while shifting the time according to the movement of the XYθ table 102. When a line sensor is used, a plurality of photosensor elements are arranged in a direction orthogonal to the scanning direction.

In the control system circuit 160, a control computer 110 on which a computer is mounted is connected to a position circuit 107, a comparison circuit 108, a reference image data creation circuit 142 (a development circuit 111 and a reference circuit 112), an autoloader control circuit 113, a table control circuit 114, a data amount control circuit 140, a magnetic disk drive 109, a flexible disk device (FD) 115, a memory 116, a CRT monitor 117, a pattern monitor 118, and a printer 119 via a bus 120. In the reference image data creation circuit 142, the development circuit 111 and the reference circuit 112 are arranged. The sensor circuit 106 is connected to the stripe pattern memory 123, and the stripe pattern memory 123 is connected to the comparison circuit 108. The XYθ table 102 is driven by an X-axis motor, a Y-axis motor, and a θ-axis motor. The XYθ table 102 is an example of a stage.

Note that a series of “circuits” such as the position circuit 107, the comparison circuit 108, the development circuit 111, the reference circuit 112, the autoloader control circuit 113, the table control circuit 114, and the data amount control circuit 140 includes a processing circuit. The processing circuit includes an electric circuit, a computer, a processor, a circuit board, a quantum circuit, or a semiconductor device. Each circuit may be configured using the same processing circuit (one processing circuit), or different processing circuits (separate processing circuits) may be used. For example, a series of “circuits” such as the position circuit 107, the comparison circuit 108, the development circuit 111, the reference circuit 112, the autoloader control circuit 113, the table control circuit 114, and the data amount control circuit 140 may be configured by the control computer 110 and executed. Input data necessary for the position circuit 107, the comparison circuit 108, the development circuit 111, the reference circuit 112, the autoloader control circuit 113, the table control circuit 114, and the data amount control circuit 140 or a calculated result is stored in a memory (not illustrated) in each circuit or the memory 116 each time. Input data necessary for the control computer 110 or a calculated result is stored in a memory (not illustrated) in the control computer 110 or the memory 116 each time. A program for executing a processor or the like may be recorded on a record carrier body such as the magnetic disk drive 109, the FD 115, or a read only memory (ROM). Note that these “circuits” are implemented on a processing device including at least a processor and a memory, and each function is realized by the processor executing an algorithm described in the present specification.

In the inspection apparatus 100, a high-magnification inspection optical system is configured by the light source 103, the XYθ table 102, the illumination optical system 170, the magnifying optical system 104, the imaging sensor 105, and the sensor circuit 106. The XYθ table 102 is driven by the table control circuit 114 under the control of the control computer 110. The XYθ table 102 is movable by a drive system such as a three-axis (X-Y-θ) motor that is driven in an X direction, a Y direction, and a θ direction. For the X-axis motor, Y-axis motor, and θ-axis motor, for example, step motors may be used. The XYθ table 102 is movable in a horizontal direction and a rotational direction by the motors of the X, Y, and θ axes. In addition, a movement position of the target object 101 arranged on the XYθ table 102 is measured by the laser length measurement system 122 and supplied to the position circuit 107.

Write data (design pattern data) to form pattern formation of the inspected target object 101 is input from an external source of the inspection apparatus 100 and stored in the magnetic disk drive 109. A plurality of figure patterns are defined in the write data. In the write data, a figure code, coordinates of a reference position, and a size are defined for each figure pattern. Alternatively, in the write data, each vertex coordinate is defined in the order of forming the figure for each figure pattern. On the target object 101, each corresponding pattern is formed based on each figure pattern defined in the write data.

Here, in FIG. 1, the configurations necessary for describing the first embodiment are described. Other necessary configurations may also be included in the inspection apparatus 100.

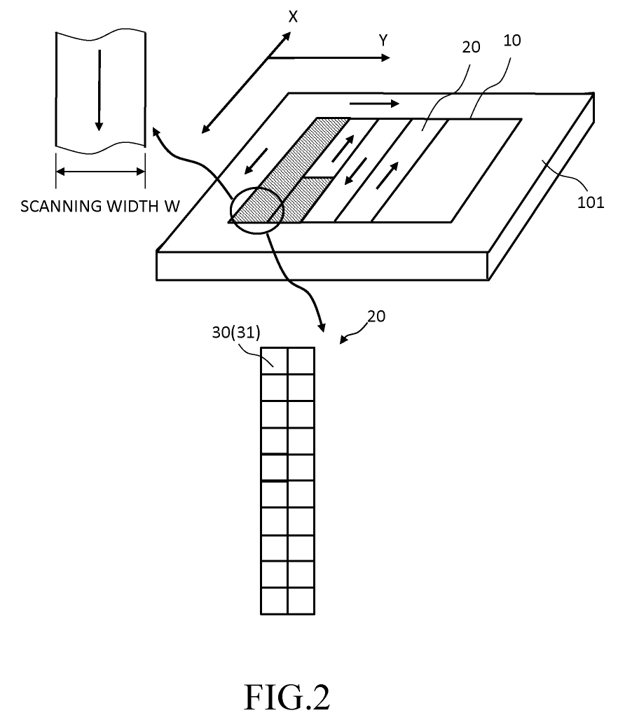

FIG. 2 is a conceptual diagram for describing an example of an inspection region in the first embodiment. As illustrated in FIG. 2, an inspection region 10 (the entire inspection region) of the target object 101 is virtually divided into a plurality of strip-shaped inspection stripes 20 (stripe regions) having a scanning width W of the imaging sensor 105, for example, in the Y direction. In addition, the inspection apparatus 100 acquires an image (stripe region image) for each inspection stripe 20. For each of the inspection stripes 20, an image of a figure pattern arranged in the inspection stripe 20 is captured in a longitudinal direction (X direction) of the stripe region using laser light (inspection light). In order to prevent missing of an image, the plurality of inspection stripes 20 are preferably set such that adjacent inspection stripes 20 overlap each other with a predetermined margin width.

The optical image is acquired while the imaging sensor 105 continuously moves relatively in the X direction by the movement of the XYθ table 102. The imaging sensor 105 continuously captures an optical image having the scanning width W as illustrated in FIG. 2. In other words, the inspection stripe is relatively scanned in the X direction (or the -X direction) by the movement of the XYθ table 102. In the first embodiment, after the imaging sensor captures an optical image in one inspection stripe 20, the imaging sensor moves to a position of the next inspection stripe 20 in the Y direction and then continuously captures an optical image having the scanning width W similarly while moving in an opposite direction. That is, imaging is repeated in a forward (FWD)-backward (BWD) direction in which a forward path and a backward path are in opposite directions.

In actual inspection, as illustrated in FIG. 2, a stripe region image of each inspection stripe 20 is divided into images (frame images 31) of a plurality of rectangular frame regions 30. In addition, the inspection is performed for each frame image 31 of the frame region 30. For example, the image is divided into a size of 512 × 512 pixels. Therefore, a reference image to be compared with the frame image 31 of the frame region 30 is similarly created for each frame region 30.

Here, the imaging direction is not limited to repetition of forward (FWD)-backward (BWD). Imaging may be performed from a single direction. For example, the imaging direction may be repetition of FWD-FWD. Alternatively, the imaging direction may be repetition of BWD-BWD.

In parallel with the scanning of a k-th inspection stripe 20, a reference image is created in real time for a (k + m)-th (m is an integer of 1 or more) inspection stripe 20 that is m stripes ahead of the currently scanned inspection stripe 20 and is not yet scanned.

Here, as described above, in a complicated pattern, since a data amount of design pattern data for forming such a pattern becomes enormous, there is a problem that reference image generation processing takes time when the reference image is created, and inspection time may be delayed in conventional processing. For example, in a case where the reference image of the (k + 1)-th inspection stripe 20 is created in parallel with the scanning of the k-th inspection stripe 20, if the data amount of the design pattern data of the (k + 1)-th inspection stripe 20 is enormous, the scanning of the (k + 1)-th inspection stripe 20 may be stopped until the reference image creation of the (k + 1)-th inspection stripe 20 is completed even if the scanning of the k-th inspection stripe 20 is completed. As a result, an inspection delay may occur.

Therefore, in the first embodiment, data processing of a part of the inspection stripe 20 that takes time to perform the data processing for creating the reference image is first completed in the inspection stripe 20 that does not take time to perform the data processing for creating the reference image. The details are described below.

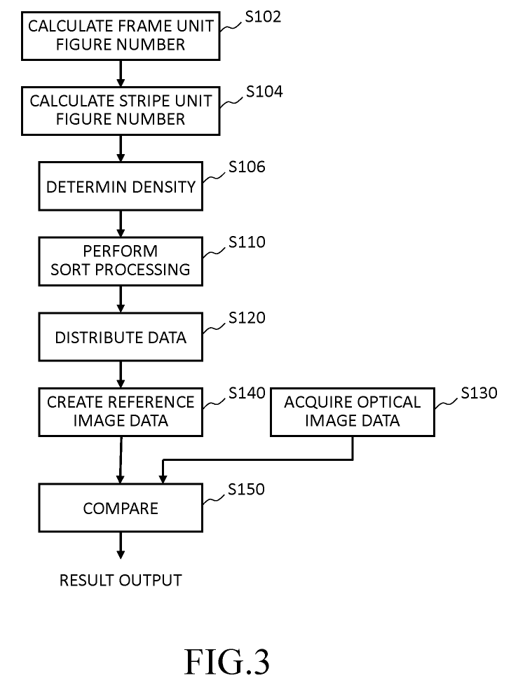

FIG. 3 is a flowchart illustrating an example of main steps of an inspection method in the first embodiment. In FIG. 3, the inspection method according to the first embodiment performs a series of steps including a frame unit figure number calculation step (S102), a stripe unit figure number calculation step (S104), a density determination step (S106), a sort processing step (S110), a data distribution step (S120), an optical image data acquisition step (S130), a reference image data creation step (S140), and a comparison step (S150).

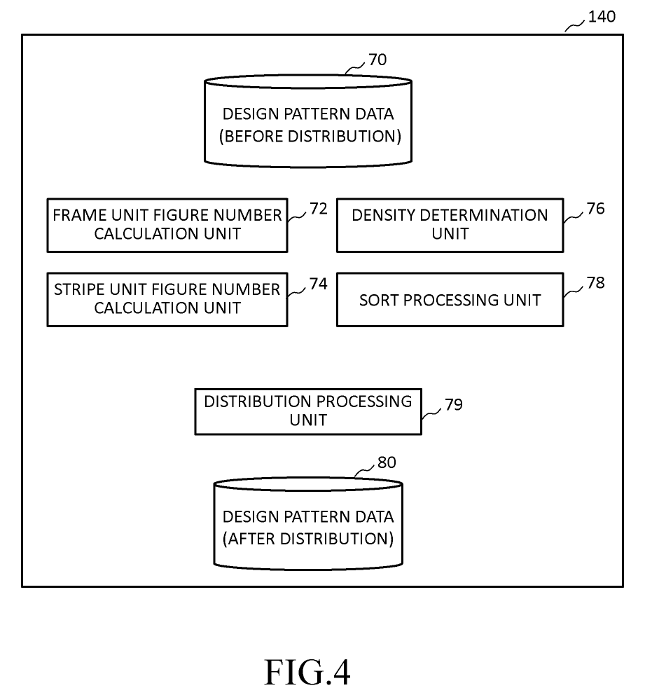

FIG. 4 is a block diagram illustrating an example of an internal configuration of a data amount control circuit in the first embodiment. In FIG. 4, storage devices 70 and 80 such as magnetic disk drives, a frame unit figure number calculation unit 72, a stripe unit figure number calculation unit 74, a density determination unit 76, a sort processing unit 78, and a distribution processing unit 79 are arranged in the data amount control circuit 140.

A series of “units” such as the frame unit figure number calculation unit 72, the stripe unit figure number calculation unit 74, the density determination unit 76, the sort processing unit 78, and the distribution processing unit 79 includes a processing circuit. The processing circuit includes an electric circuit, a computer, a processor, a circuit board, a quantum circuit, or a semiconductor device. Further, a common processing circuit (same processing circuit) may be used for each “unit”. Alternatively, a different processing circuit (separate processing circuit) may be used. Input data necessary for the frame unit figure number calculation unit 72, the stripe unit figure number calculation unit 74, the density determination unit 76, the sort processing unit 78, and the distribution processing unit 79 or a calculated result is stored in a memory (not illustrated) or the memory 116 in the data amount control circuit 140 each time.

As the frame unit figure number calculation step (S102), the frame unit figure number calculation unit 72 calculates the number of figure patterns arranged in the plurality of frame regions 30 in the inspection stripe 20 for each inspection stripe 20. Specifically, the following operation is performed. The design pattern data (write data) stored in the storage device 109 is stored in the storage device 70 in the data amount control circuit 140 for each inspection stripe 20. The frame unit figure number calculation unit 72 reads the design pattern data of the target inspection stripe 20 from the storage device 70, and counts the number of figure patterns arranged in the frame region 30 for each frame region 30. Similarly, for each inspection stripe 20 in the inspection region 10, the number of figure patterns arranged in the frame region 30 is counted for each frame region 30. In the write data, since various internal data are defined for each figure pattern, the number of data groups may instead be counted.

As the stripe unit figure number calculation step (S104), the stripe unit figure number calculation unit 74 calculates the number of figure patterns arranged in the inspection stripe 20 for each inspection stripe 20. Specifically, the following operation is performed. The stripe unit figure number calculation unit 74 may calculate the sum of the numbers of figure patterns in each frame 30 in the inspection stripe 20 already calculated.

Alternatively, the number of figure patterns arranged in the inspection stripe 20 may be calculated directly without the frame unit figure number calculation step (S102).

As the density determination step (S106), the density determination unit 76 (an example of a determination unit) determines a figure density for each inspection stripe 20 (stripe region) using write data (design pattern data) to form a plurality of figure patterns. Specifically, the following operation is performed. The density determination unit 76 determines the magnitude of the figure density by using the number of figure patterns in the inspection stripe 20 for each inspection stripe 20. Since the number of figure patterns in each inspection stripe 20 has been calculated, the density determination unit 76 determines, for each inspection stripe 20, whether or not the number of figure patterns in the inspection stripe 20 falls within a range exceeding a first threshold Th1 (upper limit threshold Th1). The number of figure patterns larger than the upper limit threshold Th1 is determined as a “large figure density”. Therefore, the inspection stripe 20 in which the number of figure patterns is larger than the upper limit threshold Th1 is determined as an inspection stripe 20-2 having a large figure density.

Next, for the inspection stripe 20 in which the number of figure patterns is not larger than the upper limit threshold Th1, the density determination unit 76 determines, for each inspection stripe 20, whether or not the number of figure patterns in the inspection stripe 20 falls within a range falling below a second threshold Th2 (lower limit threshold Th2). The number of figure patterns smaller than the lower limit threshold Th2 is determined as a “small figure density”. Therefore, the inspection stripe 20 in which the number of figure patterns is smaller than the lower limit threshold Th2 is determined as an inspection stripe 20-1 having a small figure density. The inspection stripe 20 in which the number of figure patterns is equal to or larger than the lower limit threshold Th2 and equal to or smaller than the upper limit threshold Th1 is the inspection stripe 20 of other general number of figure patterns.

As the sort processing step (S110), the sort processing unit 78 performs sort processing on at least one inspection stripe 20-2 determined to have a large figure density in order from the inspection stripe 20-2 having the larger number of figure patterns.

As the data distribution step (S120), the distribution processing unit 79 (an example of a distribution unit) distributes a part of the design pattern data of the stripe region 20-2 determined to have large figure density exceeding the upper limit threshold Th1 as a result of the determination to at least one stripe region 20-1 having a small figure density below the lower limit threshold Th2 in which optical image data is acquired before the stripe region 20-2 determined to have the large figure density.

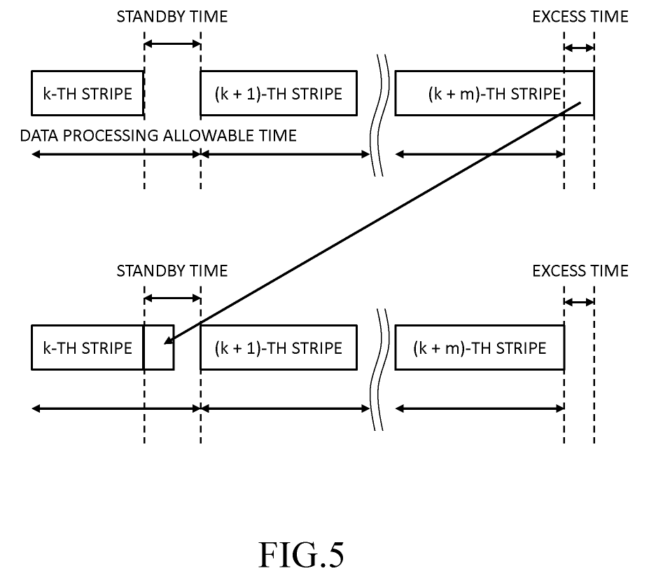

FIG. 5 is a diagram for describing an example of a model of data distribution in the first embodiment. In FIG. 5, for example, in the k-th inspection stripe 20, since the data amount of the design figure pattern data is small, reference image creation ends leaving a sufficient time within a data processing allowable time. In this case, in the k-th inspection stripe 20, reference image creation of the (k + 1)-th inspection stripe 20 is not started until the data processing allowable time ends. Therefore, a standby time is generated. On the other hand, in the (k + m)-th inspection stripe 20, since the data amount of the design figure pattern data is large, the creation of the reference image is not completed within the data processing allowable time, and the data processing allowable time is exceeded. In this case, the scanning of the (k + m)-th inspection stripe 20 cannot be started until the creation of the reference image of the (k + m)-th inspection stripe 20 is completed, and the scanning processing is stopped. Therefore, the distribution processing unit 79 distributes a part of the design pattern data of the (k + m)-th inspection stripe 20 to the k-th inspection stripe 20 (stripe which is scanned before the scanning of the (k + m)-th inspection stripe and in which optical image data is acquired accordingly). When the reference image is created in the k-th inspection stripe 20, creation of the reference image corresponding to the excess time of the (k + m)-th inspection stripe 20 is performed in advance. As a result, the creation of the reference image of the (k + m)-th inspection stripe 20 can be kept within the data processing allowable time.

The time required for the data processing of creating the reference image of the inspection stripe 20 is proportional to the number of figure patterns arranged in the inspection stripe 20. Therefore, for the inspection stripe 20-2 having a large figure density in which the number of figure patterns is larger than the upper limit threshold Th1, a part of the design pattern data is distributed to the inspection stripe 20-1 having a small figure density in which the number of figure patterns is smaller than the lower limit threshold Th2. As the upper limit threshold Th1, it is preferable to use the number of figure patterns in which a reference image can be created within the data processing allowable time. It is preferable to use design pattern data in units of frame regions as a part of the distributed design pattern data. As described above, since the reference image is created for each frame region 30, it is possible to avoid a situation in which only a part of the reference image is created at the distribution destination. Therefore, as the lower limit threshold Th2, a value having a data amount (here, the number of figure patterns) smaller than the upper limit threshold Th1 by an amount for creating at least one reference image is selected.

The distribution processing unit 79 distributes a part of the design pattern data of the inspection stripe 20-2 having the large figure density of the target within a range in which the total number of figure patterns in the distributed inspection stripe 20-1 does not exceed the upper limit threshold Th1 in order from the closer stripe region side of the small figure density to at least one inspection stripe 20-1 having the small figure density in which the optical image data is acquired before the inspection stripe 20-2 having the large figure density of the target.

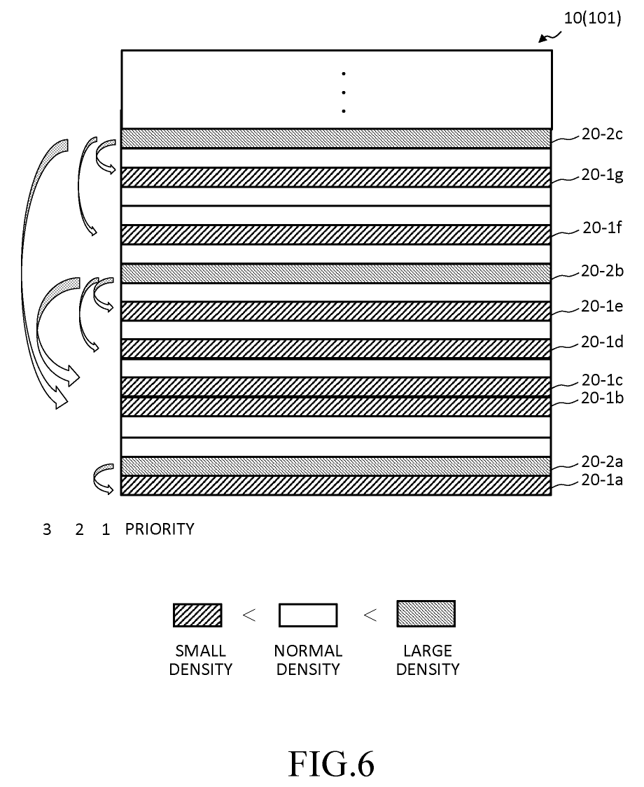

FIG. 6 is a diagram for describing an example of a manner of data distribution in the first embodiment. In FIG. 6, the inspection region 10 of the target object 101 is divided into a plurality of inspection stripes 20. In the example of FIG. 6, for example, the first inspection stripe 20 is an inspection stripe 20-1a having a small figure density. For example, the second inspection stripe 20 is an inspection stripe 20-2a having a large figure density. For example, the fifth, sixth, eighth, and tenth inspection stripes 20 are inspection stripes 20-1b, 20-1c, 20-1d, and 20-1e having a small figure density. For example, the twelfth inspection stripe 20 is an inspection stripe 20-2b having a large figure density. For example, the fourteenth and seventeenth inspection stripes 20 are inspection stripes 20-1f and 20-1g having a small figure density. For example, the nineteenth inspection stripe 20 is an inspection stripe 20-2c having a large figure density.

In the example of FIG. 6, for example, in the inspection stripe 20-2b having a large figure density, there are the five inspection stripes 20-1a, 20-1b, 20-1c, 20-1d, and 20-1e having a small figure density in which optical image data is acquired first. Here, data distribution is first performed on the inspection stripe 20-1e closest to the inspection stripe 20-2b. As a result, when the number of figure patterns in the inspection stripe 20-2b is not equal to or smaller than the upper limit threshold Th1, next, data distribution is performed on the second closest inspection stripe 20-1d. As a result, when the number of figure patterns in the inspection stripe 20-2b is not equal to or smaller than the upper limit threshold Th1, next, data distribution is performed on the third closest inspection stripe 20-1c.

For example, in the inspection stripe 20-2a having the large figure density, since the inspection stripe 20-1 having the small figure density in which the optical image data is acquired first is only the inspection stripe 20-1a, a part of the design pattern data is distributed from the inspection stripe 20-2a having the large figure density within a range in which the total number of figure patterns in the inspection stripe 20-1a having the small figure density does not exceed the threshold Th1.

Further, in the first embodiment, preferably, the distribution processing unit 79 distributes a part of the design pattern data of the stripe region having a large figure density to the stripe region having a small figure density in order from the stripe region side having a larger number of figure patterns among the plurality of stripe regions 20-2 determined to have a large figure density. Specifically, a part of the design pattern data is distributed in order from the higher stripe region side of the large figure density on which the sort processing has been performed. As a result, even in a case where the excess time at the time of creating the reference image remains, the excess time can be further shortened. In the example of FIG. 6, for example, when the number of figure patterns is large in the order of the inspection stripe 20-2b, the inspection stripe 20-2a, and the inspection stripe 20-2c, the distribution processing is performed in this order.

For example, in the inspection stripe 20-2c having a large figure density, there are seven inspection stripes 20-1a, 20-1b, 20-1c, 20-1d, 20-1e, 20-1f, and 20-1g having a small figure density in which optical image data is acquired first. Here, data distribution is first performed on the inspection stripe 20-1g closest to the inspection stripe 20-2c. As a result, when the number of figure patterns in the inspection stripe 20-2c is not equal to or smaller than the upper limit threshold Th1, next, data distribution is performed on the second closest inspection stripe 20-1f. As a result, when the number of figure patterns in the inspection stripe 20-2c is not equal to or smaller than the upper limit threshold Th1, the third closest inspection stripe is the inspection stripe 20-1e. However, since the inspection stripes 20-1c, 20-1d, and 20-1e are already used in the distribution processing in the inspection stripe 20-2b, data distribution is performed on the next closest inspection stripe 20-1b.

Alternatively, the distribution processing unit 79 may distribute a part of the design pattern data of the inspection stripe 20-2 having the large figure density of the target within a range in which the total number of figure patterns in the distributed inspection stripe 20-1 does not exceed the upper limit threshold Th1 in order from the farther inspection stripe 20-1 side of the small figure density to at least one inspection stripe 20-1 having the small figure density in which the optical image data is acquired before the inspection stripe 20-2 having the large figure density of the target.

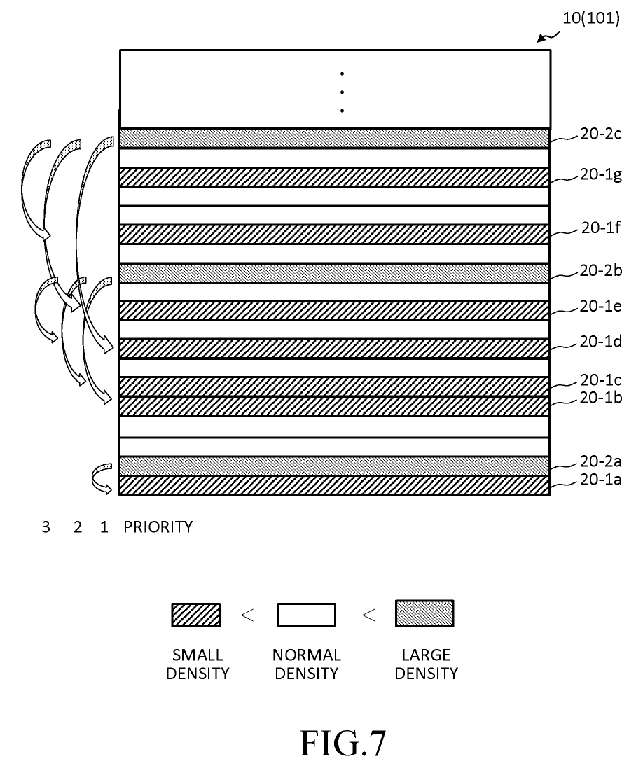

FIG. 7 is a diagram for describing another example of the manner of data distribution in the first embodiment. In FIG. 7, the inspection region 10 of the target object 101 is divided into a plurality of inspection stripes 20. In the example of FIG. 7, similar to FIG. 6, for example, the first inspection stripe 20 is an inspection stripe 20-1a having a small figure density. For example, the second inspection stripe 20 is an inspection stripe 20-2a having a large figure density. For example, the fifth, sixth, eighth, and tenth inspection stripes 20 are inspection stripes 20-1b, 20-1c, 20-1d, and 20-1e having a small figure density. For example, the twelfth inspection stripe 20 is an inspection stripe 20-2b having a large figure density. For example, the fourteenth and seventeenth inspection stripes 20 are inspection stripes 20-1f and 20-1g having a small figure density. For example, the nineteenth inspection stripe 20 is an inspection stripe 20-2c having a large figure density.

Here, when the data is distributed in sorted descending order, the earlier the inspection stripes 20-2 having a large figure density in which the optical image data is acquired earlier, the fewer the number of inspection stripes 20-1 having a small figure density that can be a distribution destination may be. Therefore, as in the related art, the data is distributed in order from the inspection stripe 20-2 having a large figure density in which the optical image data is acquired earlier among a plurality of stripe regions determined to have a large figure density.

In the example of FIG. 7, for example, in the inspection stripe 20-2a having the large figure density, since the inspection stripe 20-1 having the small figure density in which the optical image data is acquired first is only the inspection stripe 20-1a, a part of the design pattern data is distributed from the inspection stripe 20-2a having the large figure density within a range in which the total number of figure patterns in the inspection stripe 20-1a having the small figure density does not exceed the threshold Th1.

Next, for example, in the inspection stripe 20-2b having a large figure density, there are five inspection stripes 20-1a, 20-1b, 20-1c, 20-1d, and 20-1e having a small figure density in which optical image data is acquired first. Since the inspection stripe 20-1a has already been used for distribution, data distribution is first performed on the inspection stripe 20-1b farther from the inspection stripe 20-2b. As a result, when the number of figure patterns in the inspection stripe 20-2b is not equal to or smaller than the upper limit threshold Th1, next, data distribution is performed on the second farthest inspection stripe 20-1c. As a result, when the number of figure patterns in the inspection stripe 20-2b is not equal to or smaller than the upper limit threshold Th1, next, data distribution is performed on the third farthest inspection stripe 20-1d.

Next, for example, in the inspection stripe 20-2c having a large figure density, there are seven inspection stripes 20-1a, 20-1b, 20-1c, 20-1d, 20-1e, 20-1f, and 20-1g having a small figure density in which optical image data is acquired first. The inspection stripes 20-1a, 20-1b, 20-1c, and 20-1d have already been used for distribution. However, when the number of figure patterns of the inspection stripe 20-1d has not yet reached the lower limit threshold Th2, data distribution is first performed on the inspection stripe 20-1d farther from the inspection stripe 20-2c. As a result, when the number of figure patterns in the inspection stripe 20-2c is not equal to or smaller than the upper limit threshold Th1, next, data distribution is performed on the second farthest inspection stripe 20-1e. As a result, when the number of figure patterns in the inspection stripe 20-2c is not equal to or smaller than the upper limit threshold Th1, next, data distribution is performed on the third farthest inspection stripe 20-1f.

Here, when data distribution is performed, the distribution processing unit 79 distributes a part of design pattern data of the inspection stripe 20-2 having a large figure density to the inspection stripe 20-1 having a small figure density in a local area of the inspection region 10 or the entire region of the inspection region 10. In FIGS. 6 and 7 described above, the case where distribution is performed using the entire region of the inspection region 10 has been described. Next, a case where distribution is performed using a local area of the inspection region 10 will be described.

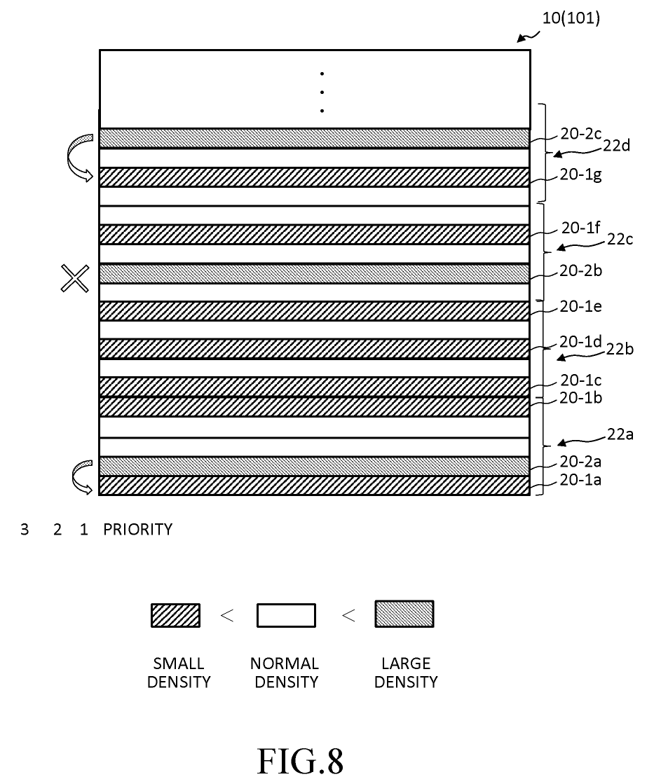

FIG. 8 is a diagram for describing another example of the manner of data distribution in the first embodiment. In FIG. 8, the inspection region 10 of the target object 101 is divided into a plurality of inspection stripes 20. In the example of FIG. 8, similar to FIGS. 6 and 7, for example, the first inspection stripe 20 is an inspection stripe 20-1a having a small figure density. For example, the second inspection stripe 20 is an inspection stripe 20-2a having a large figure density. For example, the fifth, sixth, eighth, and tenth inspection stripes 20 are inspection stripes 20-1b, 20-1c, 20-1d, and 20-1e having a small figure density. For example, the twelfth inspection stripe 20 is an inspection stripe 20-2b having a large figure density. For example, the fourteenth and seventeenth inspection stripes 20 are inspection stripes 20-1f and 20-1g having a small figure density. For example, the nineteenth inspection stripe 20 is an inspection stripe 20-2c having a large figure density.

Here, the inspection region 10 is divided into a plurality of stripe groups 22 each including n inspection stripes 20, where n is an integer. In the example of FIG. 8, for example, a case where the inspection region is divided into a plurality of stripe groups 22 each including five inspection stripes 20 is shown. Data distribution between the inspection stripes 20 is performed in the same stripe group 22 which is a local area. In other words, each stripe group 22 is used as a local area, and the distribution processing unit 79 distributes a part of design pattern data of the inspection stripes 20 having a large figure density in one stripe group to the inspection stripes 20 having a small figure density in the same stripe group.

For example, in a stripe group 22a, one inspection stripe 20-2a having a large figure density and two inspection stripes 20-1a and 20-1b having a small figure density are arranged. However, in the inspection stripe 20-1b, since an optical image is acquired after the inspection stripe 20-2a, only the inspection stripe 20-1a can be a distribution destination. Therefore, a part of the design pattern data is distributed from the inspection stripe 20-2a having a large figure density within a range in which the total number of figure patterns in the inspection stripe 20-1a having a small figure density does not exceed the threshold Th1.

For example, in a stripe group 22b, there is no inspection stripe 20-2 having a large figure density, and three inspection stripes 20-1c, 20-1d, and 20-1e having a small figure density are arranged. Since there is no inspection stripe 20-2 having a large figure density, data distribution is not performed.

For example, in a stripe group 22c, one inspection stripe 20-2b having a large figure density and one inspection stripe 20-1f having a small figure density are arranged. However, in the inspection stripe 20-1f, since an optical image is acquired after the inspection stripe 20-2b, there is no inspection stripe 20-1 having a small figure density that can be a distribution destination. Therefore, data distribution is not performed.

For example, in a stripe group 22d, one inspection stripe 20-2c having a large figure density and one inspection stripe 20-1g having a small figure density are arranged. Therefore, a part of the design pattern data is distributed from the inspection stripe 20-2c having a large figure density within a range in which the total number of figure patterns in the inspection stripe 20-1g having a small figure density does not exceed the threshold Th1.

In this way, in each inspection stripe 20, design pattern data in which the excess time of reference image creation is reduced remains. The design pattern data of each inspection stripe 20 after the data distribution is stored in the storage device 80. The inspection processing is advanced using the design pattern data of each inspection stripe 20 after the data distribution.

As the optical image data acquisition step (S130), the optical image acquisition mechanism 150 acquires optical image data for each of the plurality of inspection stripes 20 obtained by dividing the inspection region 10 of the target object 101 to be inspected on which the plurality of figure patterns are formed. The optical image data refers to data (pixel data) for each pixel of the optical image. Specifically, the following operation is performed.

First, the XYθ table 102 is moved to a position where the target inspection stripe 20 can be imaged. The pattern formed on the target object 101 is irradiated with laser light (for example, DUV light) having a wavelength in the ultraviolet region or shorter to be inspection light from an appropriate light source 103 through the illumination optical system 170. The light transmitted through the target object 101 forms an image as an optical image on the imaging sensor 105 (an example of a sensor) through the magnifying optical system 104, and enters the imaging sensor 105.

An image of the pattern formed on the imaging sensor 105 is photoelectrically converted by each light receiving element of the imaging sensor 105, and further subjected to analog/digital (A/D) conversion by the sensor circuit 106. In addition, pixel data of the inspection stripe 20 to be measured is stored in the stripe pattern memory 123. Thereafter, the stripe region image is sent to the comparison circuit 108 together with the data indicating the position of the target object 101 on the XYθ table 102 output from the position circuit 107. The measurement data (pixel data) is, for example, 8-bit unsigned data, and expresses the gradation (light amount) level of the brightness of each pixel.

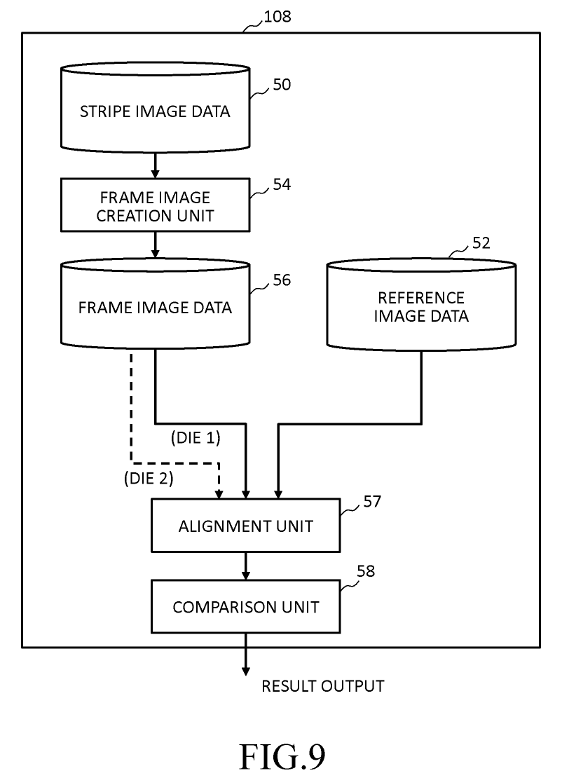

FIG. 9 is a diagram illustrating an example of an internal configuration of a comparison circuit in the first embodiment. In FIG. 9, storage devices 50, 52, and 56 such as magnetic disk drives, a frame image creation unit 54, an alignment unit 57, and a comparison unit 58 are arranged in the comparison circuit 108. A series of “units” such as the frame image creation unit 54, the alignment unit 57, and the comparison unit 58 includes a processing circuit. The processing circuit includes an electric circuit, a computer, a processor, a circuit board, a quantum circuit, or a semiconductor device. Further, a common processing circuit (same processing circuit) may be used for each “unit”. Alternatively, a different processing circuit (separate processing circuit) may be used. Input data necessary for the frame image creation unit 54, the alignment unit 57, and the comparison unit 58 or a calculated result is stored in a memory (not illustrated) or the memory 116 in the comparison circuit 108 each time.

The stripe image data output to the comparison circuit 108 is stored in the storage device 50.

Then, the frame image creation unit 54 generates a plurality of frame images 31 obtained by dividing the stripe region image (optical image) by a predetermined width. Specifically, as illustrated in FIG. 2, the stripe region image is divided into frame images of a plurality of rectangular frame regions 30. For example, the image is divided into a size of 512 × 512 pixels. The data of each frame region 30 is stored in the storage device 56.

In this way, the optical image acquisition mechanism 150 acquires the frame image 31 (measurement image and optical image) for inspection of each frame region 30 of the target object 101 to be inspected on which the pattern is formed.

As the reference image data creation step (S140), the reference image data creation circuit 142 (reference image data creation unit) creates, for each inspection stripe 20, reference image data corresponding to frame image data (optical image data) thereof using the design pattern data after distribution. The reference image data indicates data (pixel data) of each pixel of the reference image. Specifically, the following operation is performed.

First, the development circuit 111 (an example of a reference image data creation unit) creates a developed image by using design pattern data of a pattern formed in the frame image 31 of each frame 30. Specifically, the design pattern data is read from the magnetic disk drive 109 through the control computer 110, and each figure pattern of the target frame region 30 defined in the read design pattern data is converted (image development) into binary or multi-valued image data to create a developed image (representative developed image).

Here, in the figure defined in the design pattern data, for example, a rectangle or a triangle may be used as a basic figure. For example, figure data (vector data) in which a form, a size, a position, and the like of each pattern figure are defined by information such as the coordinates (x, y) at a reference position of the figure, a length of a side, and a figure code to be an identifier to distinguish a figure type such as the rectangle or the triangle is stored. Alternatively, figure data (vector data) defining the position of each vertex of the figure pattern is stored for each pattern figure.

If information of the design pattern to be the figure data is input to the development circuit 111, the data is expanded into data of each figure and a figure code showing the figure shape of the figure data, a figure dimension, and the like are interpreted. In addition, the data is expanded into binary or multi-valued design image data as a pattern disposed in a square with a grid of a predetermined quantization dimension as a unit and is output. In other words, the design data is read, an occupancy rate occupied by the figure in the design pattern is calculated for each square formed by virtually dividing the inspection region as a square with a predetermined dimension as a unit, and n-bit occupancy rate data is output. For example, it is preferable to set one square as one pixel. Assuming that one pixel has a resolution of 1/2⁸(=1/256), a small region of 1/256 is allocated by the region of the figure disposed in the pixel to calculate the occupancy rate in the pixel. Then, a developed image of 8-bit occupancy rate data is created for each pixel. Data of the developed image is output to the reference circuit 112.

The reference circuit 112 creates a reference image obtained by filtering the developed image. Since the measurement image is in a state where a filter is applied due to the resolution characteristics of the magnifying optical system 104 and the aperture effect of the imaging sensor 105, in other words, in an analog state that continuously changes, the filter processing is performed on the developed image data in which the image intensity (gray value) is data on the design side of a digital value, so that the data can be matched with the measurement data. In this way, a reference image to be compared with the optical image is created. The created reference image data is output to the comparison circuit 108 and stored in the storage device 52.

In this way, the reference image data of each inspection stripe 20 is created. In the first embodiment, since a part of the design pattern data of the inspection stripe 20-2 having a large figure density is distributed to the inspection stripe 20-1 having a small figure density, the reference image data of each inspection stripe 20 can be created within the data processing allowable time. Alternatively, even when the inspection stripe 20-2 having a large figure density exceeding the data processing allowable time is generated, the excess time can be further reduced.

As the comparison step (S150), first, the alignment unit 57 aligns the frame image 31 and the corresponding reference image for each frame region 30. For example, the alignment is performed using a least squares method or another suitable method.

The comparison unit 58 compares data (optical image data) of the frame image 31 with reference image data corresponding to the data of the frame image 31. In addition, for example, the presence or absence of a defect such as a shape defect is determined. As the determination condition, for example, both the images are compared for each pixel according to a predetermined algorithm to determine the presence or absence of a defect. In addition, a comparison result is output. The comparison result may be output to, for example, the magnetic disk drive 109, the flexible disk device (FD) 116, the CRT 117, and the pattern monitor 118, or may be output from the printer 119.

As described above, according to the first embodiment, it is possible to at least reduce a delay in the inspection time due to a delay in reference image creation.

The embodiments have been described with reference to the specific examples. However, the present disclosure is not limited to these specific examples. For example, in the embodiment, the transmitted illumination optical system using the transmitted light is illustrated as the illumination optical system 170, but the present disclosure is not limited thereto. For example, a reflected illumination optical system using reflected light may be used. Alternatively, the transmitted light and the reflected light may be simultaneously used by combining the transmitted illumination optical system and the reflected illumination optical system.

Further, descriptions of parts and the like that are not directly necessary for explanation of the present disclosure, such as an apparatus configuration and a control method, have been omitted. However, the necessary apparatus configuration and control method can be appropriately selected and used. For example, although the description of the control unit configuration for controlling the inspection apparatus 100 is omitted, the necessary control unit configuration may be appropriately selected and used.

Further, all pattern inspection apparatuses and pattern inspection methods including the elements of the present disclosure and capable of being appropriately designed and changed by those skilled in the art are included in the scope of the present disclosure.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern inspection apparatus comprising:
an optical image acquisition mechanism configured to acquire optical image data for each of a plurality of stripe regions obtained by dividing an inspection region of a target object to be inspected on which a plurality of figure patterns are formed;
a determination circuit configured to determine a figure density for each of the plurality of stripe regions by using design pattern data to form the plurality of figure patterns;
a distribution circuit configured to distribute a part of design pattern data of a stripe region determined to have a large figure density exceeding a first threshold as a result of determination by the determination circuit to at least one stripe region having a small figure density below a second threshold different from the first threshold, in which optical image data is acquired before the stripe region determined to have the large figure density;
a reference image data creation circuit configured to create, for each of the stripe regions, reference image data corresponding to the optical image data by using design pattern data after the distribution by the distribution circuit; and
a comparison circuit configured to compare the optical image data with the reference image data corresponding to the optical image data.

2. The apparatus according to claim 1, wherein the determination circuit determines a magnitude of the figure density using the number of figure patterns in the stripe region for each stripe region.

3. The apparatus according to claim 2, wherein the distribution circuit distributes a part of design pattern data of a stripe region having a large figure density of a target to at least one stripe region having a small figure density in which optical image data is acquired before the stripe region having the large figure density of the target in order from a closer stripe region side of a small figure density within a range in which a total number of figure patterns in the stripe region to be distributed does not exceed the first threshold.

4. The apparatus according to claim 2, wherein the distribution circuit distributes a part of design pattern data of a stripe region having a large figure density of a target to at least one stripe region having a small figure density in which optical image data is acquired before the stripe region having the large figure density of the target in order from a farther stripe region side of a small figure density within a range in which a total number of figure patterns in the stripe region to be distributed does not exceed the first threshold.

5. The apparatus according to claim 1, wherein the distribution circuit distributes a part of design pattern data of a stripe region having a large figure density to a stripe region having a small figure density in one of a local area of the inspection region and an entire region of the inspection region.

6. The apparatus according to claim 2, wherein the distribution circuit distributes a part of design pattern data of a stripe region having a large figure density to a stripe region having a small figure density in order from a stripe region side having a larger number of figure patterns among a plurality of stripe regions determined to have a large figure density.

7. The apparatus according to claim 5, wherein the inspection region is divided into a plurality of stripe groups each including n stripe regions, wherein n is an integer,
each stripe group is used as the local area, and
the distribution circuit distributes a part of design pattern data of a stripe region having a large figure density in one stripe group to a stripe region having a small figure density in the same stripe group.

8. The apparatus according to claim 6, further comprising a sort processing circuit configured to sort at least one stripe region determined to have large figure density in order from a stripe region having a larger number of figure patterns.

9. The apparatus according to claim 4, wherein the distribution circuit distributes a part of the design pattern data in order from a stripe region having a large figure density in which optical image data is acquired earlier among a plurality of stripe regions determined to have a large figure density.

10. A pattern inspection method comprising:
acquiring optical image data for each of a plurality of stripe regions obtained by dividing an inspection region of a target object to be inspected on which a plurality of figure patterns are formed;
determining a figure density for each of the stripe regions by using design pattern data to form the plurality of figure patterns;
distributing a part of design pattern data of a stripe region determined to have a large figure density exceeding a first threshold as a result of determination to at least one stripe region having a small figure density below a second threshold different from the first threshold, in which optical image data is acquired before the stripe region determined to have the large figure density;
creating, for each of the stripe regions, reference image data corresponding to the optical image data by using design pattern data after the distribution; and
comparing the optical image data with the reference image data corresponding to the optical image data and outputting a result.

11. The method according to claim 10, wherein the figure density is determined based on the number of figure patterns in each stripe region.

12. The method according to claim 10, wherein the first threshold and the second threshold are set based on a processing time allowed for reference image creation.

13. The method according to claim 10, wherein the distribution of the design pattern data is performed in order from the stripe region having the small figure density closest to the stripe region having the large figure density.

14. The method according to claim 10, wherein the distribution of the design pattern data is performed in order from the stripe region having the small figure density farther from the stripe region having the large figure density.

15. The method according to claim 10, wherein the inspection region is divided into a plurality of stripe groups each including n stripe regions, wherein n is an integer, and the distribution is performed in the same stripe group.

16. The method according to claim 10, wherein the distribution order for the stripe region having the large figure density is determined in order from a stripe region with a largest number of figure patterns.

17. The method according to claim 10, wherein a part of the design pattern data is distributed in order from a stripe region having a large figure density in which optical image data is acquired earlier among a plurality of stripe regions determined to have a large figure density.
